(19) United States
(12) Patent Application Publication
(10) Pub. No.: US 2020/0275148 A1
(43) Pub. Date: Aug. 27, 2020

(54) Event-Based Content Replacement In Live Media Services

(71) Applicant: QUALCOMM Incorporated, San Diego, CA (US)

(72) Inventor: Thomas STOCKHAMMER, Bergen (DE)

(21) Appl. No.: 16/720,424

(22) Filed: Dec. 19, 2019

Related U.S. Application Data
(60) Provisional application No. 62/809,883, filed on Feb. 25, 2019.

(51) Int. Cl. H04N 21/262; G06F 16/732; H04N 21/2668; H04N 21/44; G06F 16/78

(52) U.S. Cl. CPC H04N 21/26241; G06F 16/732; G06F 16/7867; H04N 21/44008; H04N 21/2668

(57) ABSTRACT

Systems, methods, and devices of various embodiments enable content replacement in streaming content, such as content of a live streaming service. Various embodiments may enable a client computing device to receive tailored content that may be suitable for playout in a single media pipeline with main content. Various embodiments may enable a client computing device to provide information to a remote server such that the remote server may provide tailored content that may be suitable for playout with main content. Various embodiments may enable a client computing device to leverage Period elements signaled outside of a content manifest to replace main content with tailored content.

### RELATED APPLICATIONS

This application claims the benefit of priority to U.S. Provisional Application No. 62/809,883, entitled “Event-Based Content Replacement In Live Media Services” filed Feb. 25, 2019, the entire contents of which are hereby incorporated herein by reference for all purposes.

### BACKGROUND

Hypertext Transfer Protocol (HTTP) streaming is one method of streaming content over the Internet. As examples, the content may be streamed according to streaming formats, such as Dynamic Adaptive Streaming Over Hypertext Transfer Protocol (DASH) or HTTP Live Streaming (HLS).

### SUMMARY

Various aspects of the present disclosure include systems, methods, and devices for content replacement in streaming content, such as content of a live streaming service. Various aspects may enable a client computing device to receive tailored content, such as ad content, that may be suitable for playout in a single media pipeline with main content, such as main content of a live streaming service. Various aspects may enable a client computing device to provide information to a remote server, such as an ad server, so that the remote server may provide tailored content that may be suitable for playout with main content. Various aspects may enable a client computing device to leverage Period elements signaled outside of a content manifest to replace main content with tailored content. In some aspects, the streaming content may be content, such as live content, streamed according to the Dynamic Adaptive Streaming Over Hypertext Transfer Protocol (DASH). The content may also be content streamed according to other streaming formats such as HTTP Live Streaming (HLS). The content may also be using Segment Formats such as the Common Media Application Format (CMAF) that conforms to multiple Streaming protocols including DASH and HLS.

Various aspects may enable a client computing device to leverage period elements signaled outside of a content manifest to replace main content with tailored content. In some aspects, remote period elements may not be added in the timeline of the MPD received by the client. Rather, in some aspects, the DASH client may place a properly constrained remote period element that contains the replacement content (e.g., an ad) on the playback timeline of the live or generally the main service.

Various aspects include methods for receiving content for a streaming service. Various aspects may include receiving a content replacement event, wherein the content replacement event indicates at least a start time and an address for a remote period that contains the replacement content, generating a conditioned request for the remote period indicated in the content replacement event, sending the conditioned request to the address for the remote period, receiving the remote period from a replacement content server in response to sending the conditioned request, and inserting the remote content into a playback timeline at the start time indicated in the content replacement event.

In some aspects, the remote content may be a remote period. In some aspects, the address for the remote period indicated in the content replacement event may be extended with query parameters. In some aspects, the query parameters may indicate at least a duration of a slot for content replacement.

In some aspects, generating the conditioned request for the remote content indicated in the content replacement event may include adding one or more query parameters indicating one or more attributes associated with the receiver device. In some aspects, the one or more attributes associated with the receiver device may include a capability of the receiver device, a time slot for insertion of replacement content, one or more properties of main content, or a last played timing of main content.

Some aspects may further include parsing the content replacement event to determine attributes of the content replacement event before generating the conditioned request, determining whether an event identifier of the content replacement event is new before generating the conditioned request, and ignoring the content replacement event in response to determining that the event identifier of the content replacement event is not new, wherein generating the conditioned request for the remote content indicated in the content replacement event may include generating the conditioned request for the remote content indicated in the content replacement event in response to determining that the event identifier of the content replacement event is new.

In some aspects, the content replacement event may further indicate a duration. Some aspects may further include determining whether the start time indicated in the content replacement event has passed before generating the conditioned request, determining whether the duration has expired in response to determining that the start time has passed and before generating the conditioned request, and ignoring the content replacement event in response to determining that the start time has passed and the duration has expired, wherein generating the conditioned request for the remote content indicated in the content replacement event may include generating the conditioned request for the remote content indicated in the content replacement event in response to determining that the start time has not passed or the start time has passed and the duration has not expired.

Some aspects may further include receiving a second content replacement event, wherein the content replacement event indicates at least a second start time and a return to main content, and returning to playing main content at the second start time in response to receiving the second content replacement event.

In some aspects, the remote content may include replacement content to be spliced into the main content at the start time indicated in the content replacement event. In some aspects, the replacement content may be tailored replacement content. In some aspects, the replacement content may be filled for the duration of the remote content. In some aspects, the remote content may indicate the replacement content may be terminated earlier than the duration of the remote content. Some aspects may further include splicing the replacement content into the main content. In some aspects, splicing the replacement content into the main content may include adjusting a duration of the replacement content in response to the remote content indicating that the replacement content may be terminated earlier than the duration of the remote content.

In some aspects, the main content and replacement content may be DASH content. Some aspects may further include playing the main content and the replacement content from a same buffer seamlessly.

Further aspects include a computing device including a processor configured with processor-executable instructions for performing operations of any of the methods described herein. Further aspects include a non-transitory processor-readable medium on which is stored processor-executable instructions configured to cause a computing device to perform operations of any of the methods described herein. Further aspects include a computing device including means to perform operations of any of the methods described herein.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a communication system block diagram of a network suitable for use with various embodiments.

FIG. 2 is a block diagram illustrating the architecture of a receiver device according to an embodiment.

FIG. 3 is a block diagram illustrating a message exchange architecture between a receiver device, a content server, a manifest generator server, and a replacement content server according to an embodiment.

FIG. 4 is a call flow diagram illustrating interactions between a receiver device, a content server, a manifest generator server, and a replacement content server to insert replacement content into a stream of main content according to an embodiment.

FIG. 5 is a process flow diagram illustrating a method for generating content replacement events according to various embodiments.

FIG. 6 is a process flow diagram illustrating a method for receiving content for a streaming service according to various embodiments.

FIG. 7 is a process flow diagram illustrating a method for generating a remote period according to various embodiments.

FIG. 8 is a timeline of playout of a streaming service in response to a content replacement event at two different receiver devices according to various embodiments.

FIG. 9 is a component diagram of an example mobile device suitable for use with the various embodiments.

FIG. 10 is a component diagram of an example server suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the disclosure or the claims. Alternate embodiments may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any implementation described herein as “exemplary” is not necessarily to be construed as preferred or advantageous over other implementations.

As used herein, the terms “mobile device”, “computing device”, and “receiver device” are used interchangeably herein to refer to any one or all of cellular telephones, smart phones, personal or mobile multi-media players, laptop computers, tablet computers, smart books, palm-top computers, multimedia Internet enabled cellular telephones, wireless gaming controllers, and similar personal electronic devices that include a programmable processor, a wireless transceiver, memory, and circuitry configured to provide the functionality described herein.

The various embodiments are described herein using the term “server” to refer to any computing device capable of functioning as a server, such as a master exchange server, web server, mail server, document server, content server, or any other type of server. A server may be a dedicated computing device or a computing device including a server module (e.g., running an application that may cause the computing device to operate as a server). A server module (e.g., server application) may be a full function server module, or a light or secondary server module (e.g., light or secondary server application) that is configured to provide synchronization services among the dynamic databases on receiver devices. A light server or secondary server may be a slimmed-down version of server-type functionality that can be implemented on a receiver device thereby enabling it to function as an Internet server (e.g., an enterprise e-mail server) only to the extent necessary to provide the functionality described herein.

Hypertext Transfer Protocol (HTTP) streaming is currently the most popular method of delivering content over the Internet. For live events, content is made available progressively through constant duration segments. The segment availability follows a timeline that indicates when each successive segment becomes available at the HTTP server. The content may be streamed according to streaming formats, such as Dynamic Adaptive Streaming Over Hypertext Transfer Protocol (DASH) or HTTP Live Streaming (HLS). Streaming Formats typically consider two types of main formats, the manifest providing instructions on where and when to access the Segments, and the Segment Formats that contain the actual media content in a downloadable and timed fashion. Where in the following the focus is on DASH and the term Media Presentation Description (MPD) is used for the manifest, the same concepts apply to other streaming formats that consist of a manifest and Segment formats. For HLS as an example, the manifest is referred to as am M3U8 playlist. The streaming formats may also be using Segment Formats such as the Common Media Application Format (CMAF) that conforms to multiple Streaming protocols including DASH and HLS.

Dynamic Adaptive Streaming Over Hypertext Transfer Protocol (DASH) is a standard that implements HTTP streaming DASH announces the segment availability in a manifest file referred to as a Media Presentation Description (MPD). The MPD is a segment availability timeline that announces the segments location (typically a (Uniform Resource Locator (URL) to an HTTP Server), the times segments are available, and possibly the size of the segments. A DASH client running on a processor of a receiver device, such as a DASH client providing content to an adaptive bitrate (ABR) player, uses the MPD to request and receive segments of a service, such as segments of a live service. The Third Generation Partnership Project (3GPP) has standardized DASH over Download Delivery as a method to be used for providing HTTP streaming using broadcast over Long Term Evolution (LTE) (i.e., evolved Multimedia Broadcast Multicast Services (eMBMS)).

In many DASH implementations it is assumed that a streaming service author (e.g., a broadcaster of a live program service, such as a sporting event, concert, etc.) has full knowledge on the content authoring. Many DASH implementations assume the streaming service author controls both the main content generation and the replacement content, such as ad content, alternate language content, region specific content, etc., generation for splicing into the main content. However, in many cases replacement content is provided from a separate library and is independent of the main content and/or streaming service author. For example, a broadcaster may provide streaming content of a live sporting event (e.g., the main content), while inserted ads (e.g., the replacement content) may be provided from a separate service (e.g., an ad server).

Various examples of different types of replacement content are discussed herein, such as ad content, alternate language content, region specific content, etc. The discussions of these types of replacement content, such as ad content, alternate language content, region specific content, blackout content, etc., are provided merely as examples to better illustrate the aspects of the various embodiments, and are not intended to limit the various embodiments or the claims in any way. Other types of replacement content may be substituted in the various examples without departing from the scope of the claims. Ad content is specifically used as an example herein of a type of replacement content as ad insertion is a common business case in content streaming However, ad content is merely an example of one type of replacement content, and any type of replacement content may be substituted for ad content as described herein.

While ads may be considered “annoying” in general, there is a significant benefit if the ad is of high quality and, especially, the transitioning into the ad from the main content, as well as the transitioning from the main content to the add, are of high quality (also referred to as seamless). A high quality ad may be an ad that matches the device capabilities and/or an ad that correctly supports interactivity when available. A high quality ad may also be an ad that has its quality matched to the currently playing main content, such as an ad that avoids any High-Definition Multimedia Interface (HDMI) resets, avoids source buffer re-initialization, avoids unnecessary black frames due to content splicing, avoids encryption and protected content mismatches, avoids different audio codec configurations and possibly resulting audio glitches, etc. A high quality ad may meet the encoding requirements (timing, splicing) of the ad at the ad splice point. A high quality ad may be personalized to a user, for example based on user identifiers, geolocation, etc. A high quality ad may match the duration of the ad slot in the main content.

Especially the issue of the quality of the ad matching the quality of the main content currently being played has been ignored largely in current systems because many workflows are vertical and content providers condition their ads. However, with more and more content formats, device capabilities, and different ad formats becoming prevalent, there is a benefit in providing an ad server with as much information as possible in order to provide a high-quality spliced ad adjusted to the current playback conditions.

Another issue that is unresolved in current systems is the problem of splicing content for which two media types, typically audio and video, have different “end times” before the splice point, or have different starting times. Overlap in current systems may be difficult, especially in a single source buffer, as the splice point is ambiguous. Gaps may cause issues in current systems because the playback gets stalled or interrupted.

Another potential drawback to current systems is that the receiver device may need two source buffers (e.g., media decoding elements), one buffer to support ad playback and one buffer for the main content.

The insertion of ads into DASH, or any ABR live service, is a major opportunity, but also a challenge. A common approach is the use of Periods with Extensible Markup Language (XML) Linking Language (XLink) pre-placed in a manifest, such as an MPD, sent to a receiver device. The Period element in the MPD provides a URL to an ad server and the resolution of this request provides a fully compatible Period structure that is placed in the timeline of the main live service. Live services are typically supported by extending the timeline with every segment. This is typically verified by information for the live service, e.g., an updated manifest or by the absence of in-band event message that terminates the event or triggers a manifest update. The usage of regular DASH Period elements, that are placed in the time line itself, may create no problems for live services if the ad slots are accurately timed and the ads exactly match the times of the provided time slot (both when leaving the main content and transitioning to the ad, as well as when exiting the ad and going back to the main content). This is because the DASH client plays the received replacement content and plays the ad without even recognizing the playback is an ad. At the end of the ad, the return to the live service is supported by providing a new Period element in the manifest that enables the DASH client to return to the live service.

While DASH Period element indications in a manifest may potentially work seamlessly, in current systems there are several cases for which exact timing and placement of the ad is not supported. In such cases the placement of Period elements in the originally provided timeline (e.g., originally provided manifest for the main content of the live service, such as the originally provided MPD for the live service and/or any update of the MPD sent to the receiver device) cannot meet the requirements of the DASH timing model. As an example, Period elements in the original timeline do not work effectively when the ad is provided as a pre-roll to the live service when a client joins the live service. The main content is not conditioned for arbitrary joining receiver devices whenever the initial ad is terminated. A Period element cannot be added to provide an exact timeline as receiver device pre-roll upon joining is arbitrary based on when the receiver device joins. As another example, Period elements in the original timeline do not work effectively when an ad is offered during the live service, but the targeted ad does not exactly match the time of the provided timeline. In this case, the Period element of the ad does not create a proper continuous timeline for the receiver device and the receiver device needs to act to compensate for the mismatch. As a further example, Period elements in the original timeline do not work effectively when an ad opportunity is offered with a defined duration, and an ad is inserted matching this duration, but the live service wants the DASH client to terminate the ad playback early and return to the live service. This typically occurs when the MPD packager sends an MPD update that includes a period that terminates the ad, for example when the live event continues earlier than expected. In all of these examples, the main issue is that the Period element in the original timeline does not allow an ad to be correctly placed and inserted in the live timeline.

These issues with ad timing have been addressed to some extent by providing two media decoding pipelines that are both running in parallel, one for the live service and one for the ad decoding and processing. On the presentation level, only the ad is presented and the live service is hidden during ad presentation. In addition, there are some methods to address the ad timing issues that rely on signaling that needs a separate processor (such as SCTE-35 clients) on the playback device that interprets the logic and the ad placement. However, all of these approaches result in the problem that two media pipelines need to be supported. Two media pipelines are often not supported by receiver devices, and even if it is, may place a significant resource and processing burden on resource constrained receiver devices, such as mobile devices. In addition, proper signaling of this two media pipeline behavior is not supported in DASH.

Systems, methods, and devices of various embodiments enable content replacement in streaming content, such as content of a live streaming service, without requiring two media pipeline capabilities. Various aspects may enable a receiver device to receive tailored replacement content, such as ad content, that may be suitable for playout in a single media pipeline with main content, such as main content of a live streaming service. Various aspects may enable a client computing device to provide information to a remote server, such as a replacement content server, such that the remote server may provide tailored content that may be suitable for playout with main content, such as main content of a live streaming service. In some aspects, the streaming content may be DASH content.

Various aspects may enable a client computing device to leverage period elements signaled outside of a content manifest to replace main content with tailored content. In some embodiments, remote period elements may not be added in the timeline of the MPD received by the client. Rather, in some embodiments, the DASH client may place a properly constrained remote period element that contains the replacement content (e.g., an ad) on the playback timeline.

In some embodiments, the address (e.g., a Uniform Resource Locator (URL)) to the remote server providing the remote period element (e.g., a replacement content server, an ad server, etc.), the start time, the considered duration, as well as other information, may be provided in a content replacement event. A content replacement event may be a timed DASH event, such as an MPD Event or inband event. The content replacement event may be parsed by the DASH client and the DASH client may act and download the remote period in response to the content replacement event. The DASH client may place the remote period timeline (e.g., an ad period timeline) on top of the continuing live service. In some embodiments, the requested remote period may be properly conditioned, for example by taking into account dynamic information sent in the request for the remote period sent by the receiver device receiving the content replacement event.

In some embodiments, the DASH client may continue to consume the live service in a sense that at least the DASH client updates the MPD and/or observes event streams for MPD updates. This may enable the packager of the live service (e.g., the content server supporting the live service) to signal, for example, the early termination of the content replacement event (e.g., an early termination of an ad), the extension of the content replacement event (e.g., an extension of an ad opportunity), and/or other related information via events sent as part of the live service. As the DASH client may stay connected to the live service content server while playing replacement content in some embodiments, content replacement events and possibly other events such as MPD validity expiration events may be received during playout of replacement content.

In various embodiments, as the remote Period is properly conditioned, the DASH client of a receiver device is able to splice the replacement content (e.g., an ad) in the same media element/source buffers for playback of main content. In this manner, content replacement events may enable a single buffer to be used for playback of both main content and replacement content (e.g., ads) in receiver devices.

In various embodiments, a content replacement event that signals a remote period may provide, at least, the start time of the content replacement opportunity (e.g., the start time of the ad insertion opportunity, etc.), the planned duration of the content replacement opportunity (e.g., the planned duration of the ad insertion opportunity, etc.), and the address (e.g., URL) where the receiver device may retrieve the remote period. In some embodiments, the information indicated in the content replacement event may be fully processed by a DASH client and may not need to be passed to an application interfacing with the DASH client, such as a media player. Enabling the DASH client to fully process content replacement events on its own may avoid additional processing. In some embodiments, the start time indicated in the content replacement event maps to the media timeline. The start time may be conditioned such that it coincides with the end of a segment or a period to simplify insertion into the client's media playback process.

In some embodiments, a specific value of the start time in the content replacement event may be defined by a special event time value that indicates the content replacement event is signaling a remote period to be played when the receiver device joins the service. In some embodiments, the start time in the content replacement event may be set to the start time of the first segment of the service or the first segment of the latest Period and the duration set to infinite (or extremely long) such that the start time and duration ensure the event will start even after the receiver device has joined the service after start time of the service. Additionally, the content replacement event may include additional information that supports the replacement content insertion process.

In some embodiments, the remote period may have a format as defined in International Organization for Standardization (ISO)/International Electrotechnical Commission (IEC) (ISO/IEC) standard 23009-1. In some embodiments, the remote period may include an indication that the replacement content for the remote period may be shortened without impacting the user experience. For example, the remote period may include an attribute (e.g., “@earlyTermination”) indicating the replacement content may be terminated earlier than the duration of the remote period. For example, the indication that early termination is acceptable for the replacement content may be an indication of a time during the ad when the audio is mute and the ad has black frames, such as the last three seconds of the ad. This mute/black frame period may permit easier conditioning of the ad on insertion by a receiver device. In some embodiments, the presence of both a duration attribute (e.g., “@duration”) and the attribute indicating the replacement content may be terminated earlier than the duration of the remote period (e.g., “@earlyTermination”), may signal to the DASH client of a receiver device that the value of the attribute indicating the replacement content may be terminated earlier than the duration of the remote period (e.g., “@earlyTermination”) specifies that the remote Period may be terminated earlier by at most the value of the attribute indicating the replacement content may be terminated earlier than the duration of the remote period (e.g., “@earlyTermination”) in the playback rather than the time signaled by the duration attribute (e.g., “@duration”).

In some embodiments, content replacement events (e.g., DASH content replacement events) may be instructions in the content that the DASH client is to replace content from a specific media time onwards for some time by a period that is provided from a remote server (e.g., a replacement content server, such as an ad server, etc.). In some embodiments, these content replacement events (e.g., DASH content replacement events) may be identified by the Uniform Resource Name (URN)(“urn:mpeg:dash:eventreplacement:2019”). In some embodiments, a content author (e.g., a content server) may use such a content replacement event (e.g., DASH content replacement event) for replacing a certain part of the main content of a service and/or replacing a certain part of replacement content. In some embodiments, a content author may also use such a content replacement event (e.g., DASH content replacement event) for terminating an earlier signaled event. Early termination of such a content replacement event (e.g., DASH content replacement event) may be achieve in some embodiments by adding a URN “urn:mpeg:dash:event:replacement:main:2019” into a content replacement event. In some embodiments, a DASH client may follow this event stream, as well as regular MPD updates, while playing back the replacement content.

In some embodiments, a content replacement event may include a scheme identifier uniform resource identifier (URI) (e.g., @shcemeldURI). The scheme identifier may be set to “urn:mpeg:dash:event:replacement:2019” to signal the content replacement event. In some embodiments, the content replacement event may include an event identifier of the content replacement event. Content replacement events may have unique content replacement identifiers such that content replacement events may be distinguished from one another. In some embodiments, the content replacement event may include a start time (e.g., start_time). The start time may provide the nominal start time of the replacement content in the media timeline.

In some embodiments, the content replacement event may include a value field. The value field may indicate whether the remote period indicated by the content replacement event is played from the time that matches since the start of the event has passed (e.g., by a value field setting of “1”) or whether the remote period is played from the start, regardless at what time the event is joined and played until the end (e.g., by a value field setting of “2”).

In some embodiments, the content replacement event may include a duration (e.g., duration). The duration may provide the range for which the event may be started after the start time. If set to 0, then only when media time with value start_time is played may the content replacement happens. If greater than 0, the content replacement can also happen in a media time later than start_time, maximally at start_time+duration. For preroll content replacement, start_time is set to the presentation time offset of the period and duration is set to a very large value, e.g., the expected duration of the period. In such instances, the value field may be set to “2”.

In some embodiments, the content replacement event may include a message. The message may provide a URL to a remote period. In some embodiments, the URL to the remote period may be extended with query parameters to signal the duration of the content replacement slot, as well as other parameters. For example, the URL may be extended to indicate query parameters representing the duration, the maximum duration delta (e.g., MaxDurationDelta), and/or the minimum duration delta (e.g., MinDurationDelta). The duration may provide the nominal duration of the content replacement slot. The maximum duration delta may provide the maximum duration delta of the content replacement slot and the minimum duration delta may provide the minimum duration delta of the content replacement slot. In some embodiments, the message may be set to “urn:mpeg:dash:event:replacement:main:2019”. Setting the message to “urn:mpeg:dash:event:replacement:main:2019” may indicate that the Period that includes the event stream (e.g., the main content stream) is to be played. This may also be considered as a self-reference. The return to the main content happens earliest at start_time, and latest at start_time+duration. Values in the content replacement event may be mapped to presentation time, duration, and the message of the event and may be carried in the MPD or inband.

In some embodiments, a remote period referenced in a content replacement event may include a period duration attribute (e.g., period@duration). The availability time offset (e.g., @availabilityTimeOffset) may be set to infinity or to a large number to indicate that all Segments in the remote period are available. In some embodiments, the replacement content for the remote period may be filled for the entire duration of the remote period, for example there may be no gaps at the start or end. In some embodiments, when the early termination attribute (e.g., @earlyTermination) is included in the remote period referenced in a content replacement event, the attribute may indicate that the replacement content may be terminated earlier than indicated by the duration attribute of the remote period (e.g., @duration).

In some embodiments, a receiver device may add query parameters to the address (e.g., the URL) indicated in a content replacement event before sending a conditioned request for the remote period referenced in the content replacement event to a remote server (e.g., a replacement content server, such as an ad server, etc.). Additional query parameters added by the receiver device may include one or more query parameters indicating one or more attributes associated with the receiver device. The one or more attributes associated with the receiver device may include a capability of the receiver device, a time slot for insertion of replacement content, one or more properties of main content, and/or a last played timing of main content.

The additional query parameters may include conditioning parameters such as the initialization sets for the content currently being played back by the receiver device. The additional query parameters may indicate the desired value of the @start attribute of the remote period in the MPD. The additional query parameters may make the remote server (e.g., a replacement content server, such as an ad server, etc.) aware of the currently playing content, personalization information, etc., as well as the capabilities of the receiver device. As examples, the information associated with the currently playing content at the receiver device may be determined by the receiver device based on the Movie Header/Initialization Segment/Common Media Application Format (CMAF) Header of each playing track which may provide a good overview on the codecs, formats, etc. being used in playout. As other examples, the information associated with the currently playing content at the receiver device may be determined based on manifest parameters, Multipurpose Internet Mail Extension (MIME) types with codec sub-parameters, etc. The inclusion of information associated with the currently playing content may enable the remote server (e.g., a replacement content server, such as an ad server, etc.) to select proper replacement content that matches the current playback.

In addition, the additional query parameters may include the presentation time of the last presented sample in order to provide a continuous presentation. In addition, the replacement content insertion time slot, such as the ad insertion time slot, may be indicated as additional query parameters. The indication of the replacement content insertion time slot, such as the ad insertion time slot, may enable the remote server (e.g., a replacement content server, such as an ad server, etc.) to accurately select the replacement content and replacement content boundaries (e.g., the ad and ad boundaries). In addition, the last played timing of the main content for each media component may be provided as additional query parameters.

The capabilities of the receiver device indicated as additional query parameters may include indications related to how the receiver device handles insertion of replacement content, such as ad content. As examples, the capability indicated may be an indication the receiver device uses a single source buffer with static initialization, the capability indicated may be HDMI properties of the receiver device, the capability indicated may be an indication the receiver device uses multiple source buffers, the capability indication may be an indication of the receiver device's regular Media Source Extension (MSE) operation, etc.

In some embodiments, the receiver device may act on content replacement events when subscribed to a content replacement event stream. In some embodiments, the receiver device may ignore content replacement events with event identifiers (e.g., event IDs) that have already been received. In this manner, duplicate content replacement events may not be processed.

In some embodiments, in response to a content replacement event being received with a new event identifier (e.g., event ID), the receiver device, and for example the DASH client of the receiver device, may take action on the content replacement event based on information determined by parsing the content replacement event and the state of playout of the service (e.g., playing replacement content, playing main content, etc.). For example, the DASH client may use the start time of the content replacement event to determine when the replacement content will happen. If the start time has passed, but the content replacement event duration indicates that it is still within the duration, then the replacement content may be played, depending on the value being set. If the message element of the content replacement event is set to “urn:mpeg:dash:event:replacement:main:2019” and the DASH client is playing the main content, the DASH client may continue to play the main content. If the message element of the content replacement event is set to “urn:mpeg:dash:event:replacement:main:2019” and the DASH client is playing replacement content, the DASH client may return to the main content at start_time of the main content (i.e., the start_time indicated in the content replacement event indicating to return to main content). If the start time has passed, but the media time is still within the duration of the content replacement event indicating to return to main content, then the return to main content may happen as soon as possible. If the message element of the content replacement event is set to a regular URL, then the DASH client may issue a request for the content to a remote server, such as a replacement content server (e.g., an ad server).

The DASH client may add additional query parameters. The additional query parameters indicate one or more attributes associated with the receiver device. As some examples, the one or more attributes associated with the receiver device may include a capability of the receiver device, a time slot for insertion of replacement content, one or more properties of main content, and/or a last played timing of main content.

Once the remote period is received, the DASH client may place this remote period into its playback timeline as follows. Placing the remote period into the playback timeline may include setting the Period@start such that it matches the presentation time of the content replacement event in the main content. The remote period is played following the @duration attribute, possibly using the @earlyTermination, and after playing, the DASH client returns playout to the main content at the presentation time that matches the remote period duration. This may be equivalent to playing the main content with presentationTimeOffset set to start_time+the duration of the replacement content. The exact transition may be an adjusted earlyTermination value if provided.

In some embodiments, any time a new content replacement event is received, the replacement may happen according to the newest content replacement event. In this mariner, even if replacement content is already played, a new event results in a new replacement (e.g., the replacement of replacement content).

Various embodiments are discussed herein with reference to remote periods. Remote periods are merely one example of remote content that may be indicated by a content replacement event and other types of remote content may be substituted for remote periods in the various examples described herein. The discussions of remote periods are provided merely as examples to better illustrate aspects of the various embodiments, and are not intended to limit the claims or the various embodiments in any way. Other types of remote content may be used with the various embodiments.

Various examples of different applications/clients, middleware, segment availability timelines, radio technologies, and transport protocols are discussed herein, specifically DASH clients, Multicast Service Device Clients, MPDs, eMBMS, and HTTP. The discussions of DASH clients, Multicast Service Device Clients, MPDs, eMBMS, and HTTP are provided merely as examples to better illustrate the aspects of the various embodiments, and are not intended to limit the various embodiments in any way. Other applications/clients, middleware, segment availability timelines, radio technologies, and transport protocols may be used with the various embodiments, and the other applications/clients, middleware, segment availability timelines, radio technologies, and transport protocols may be substituted in the various examples without departing from the scope of the claims. For instance, various embodiments may use segments formatted according to one or more other adaptive streaming protocols, such as, HTTP Live Streaming (HLS), that may use other segment availability timelines, such as, an HLS index file, that may have a start time.

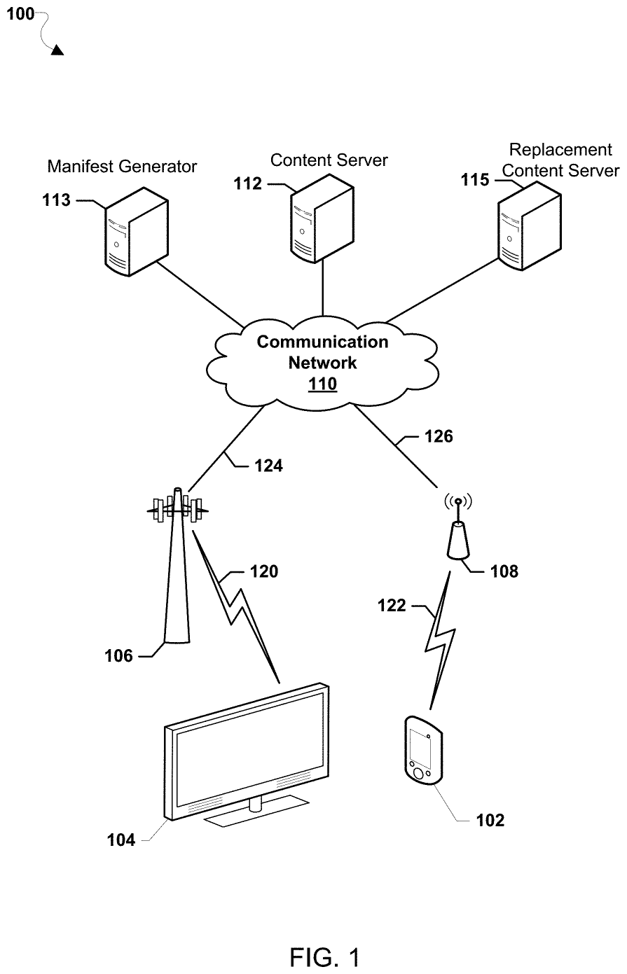

Various embodiments may be implemented in a variety of communication systems, such as a communication system 100, an example of which is illustrated in FIG. 1.

A receiver device (such as the receiver devices 102 and 104) may communicate with a communication network 110. The communication network 110 may include a base station 106, an access point 108, and various network elements, such as a content server 112, a manifest generator server 113, and a replacement content server 115 (e.g., an ad server, alternate language content server, region specific content server, etc). The base station 106 may communicate with the communication network 110 over a wired or wireless communication link 124, and the access point 108 may communicate with the communication network 110 over a wired or wireless communication link 126. The communication links 124 and 126 may include fiber optic backhaul links, microwave backhaul links, and other communication links. In some embodiments, the communication network 110 may include a cellular communication or mobile telephony communication network. In various embodiments, the communication network 110 may include a cellular broadcast system. The receiver devices 102 and 104 may communicate with the base station 106 over a wireless communication link 120, and with the access point 108 over a wireless communication link 122. Of course, while features of receiver devices described herein, such as receiver devices 102, 104, may be described with reference to wireless transmissions, these features may be used in connection with any type of transmission of content, such as wired transmissions, over-the-air (OTA) transmissions, a combination of wired and wireless transmissions, etc.

The content server 112 may be any type of server configured to provide content data for the receiver devices 102 and 104, such as a television provider server, Over-the-Top (OTT) service provider server, Broadcast-Multicast Service Center (BM-SC), BCMCS (Broadcast and Multicast Service) Content Server, a media server, etc. The content server 112 may communicate with the communication network 110 over a wired and/or wireless communication link. The content server 112 may exchange data with the receiver devices 102, 104 via the communication network 110 and the receiver devices' 102, 104 various connections to the communication network 110. The content server 112 may make streaming services available to the receiver devices 102, 104, such as live streaming services. For example, the content server 112 may include an encoder outputting DASH segments of a live stream. The content for a service made available to the receiver devices 102, 104 from the content server 112 may be referred to herein as “main content.” The content server 112 may exchange data with the manifest generator server 113 and the replacement content server 115 via the communication network 110.

The manifest generator server 113 may communicate with the communication network 110 over a wired and/or wireless communication link. The manifest generator server 113 may receive indications of content to be streamed from the content server 112 and may generate and send manifests and/or manifest updates reflecting that content to other devices, such as the replacement content server 115, receiver devices 102, 104, etc., via the communication network 110. For example, the manifest generator may output DASH MPDs and/or DASH MPD updates for segments of a live stream. The manifest generator server 113 may exchange data with the receiver devices 102, 104 via the communication network 110 and the receiver devices' 102, 104 various connections to the communication network 110. The manifest generator server 113 may exchange data with the content server 112 and the replacement content server 115 via the communication network 110. While illustrated as a separate device, the manifest generator server 113 may optionally be an element of the content server 112 itself.

The replacement content server 115 may communicate with the communication network 110 over a wired and/or wireless communication link. The replacement content server 115 may receive manifests and/or manifest updates from the manifest generator server 113. The replacement content server 115 may exchange data with the receiver devices 102, 104 via the communication network 110 and the receiver devices' 102, 104 various connections to the communication network 110.

The replacement content server 115 may make replacement content available for insertion by the receiver devices 102, 104 into streaming services being provided by the content server 112, such as live streaming services. For example, the replacement content server 115 may include an encoder outputting DASH segment of replacement content for insertion into a live stream. Replacement content may be any type of content that replaces the main content from the content server 112 for a period of time, such as ad content, alternative language content, region specific content, etc. The replacement content server 115 may generate sub-manifests for replacement content and provide the sub-manifests to the receiver devices 102, 104 via the communication network and the receiver devices' 102, 104 various connections to the communication network. The replacement content server 115 may exchange data with the manifest generator server 113 via the communication network 110.

The communication network 110 may support communications using one or more radio access technologies, and each of the wireless communication links 120 and 122 may include cellular connections that may be made through two-way wireless communication links using one or more radio access technologies. Examples of radio access technologies may include 3GPP Long Term Evolution, (LTE), Global System for Mobility (GSM), Code Division Multiple Access (CDMA), Time Division Multiple Access (TDMA), Wideband CDMA (WCDMA), Worldwide Interoperability for Microwave Access (WiMAX), Fifth Generation (5G) New Radio (5G NR), a radio access protocol in the Institute of Electrical and Electronics Engineers (IEEE) 802.11 or IEEE 802.15 family of protocols (e.g., Wi-Fi, Bluetooth, etc.), and other radio access technologies. While the wireless communication links 120 and 122 are illustrated as single links, each of the communication links may include a plurality of frequencies or frequency bands, each of which may include a plurality of logical channels.

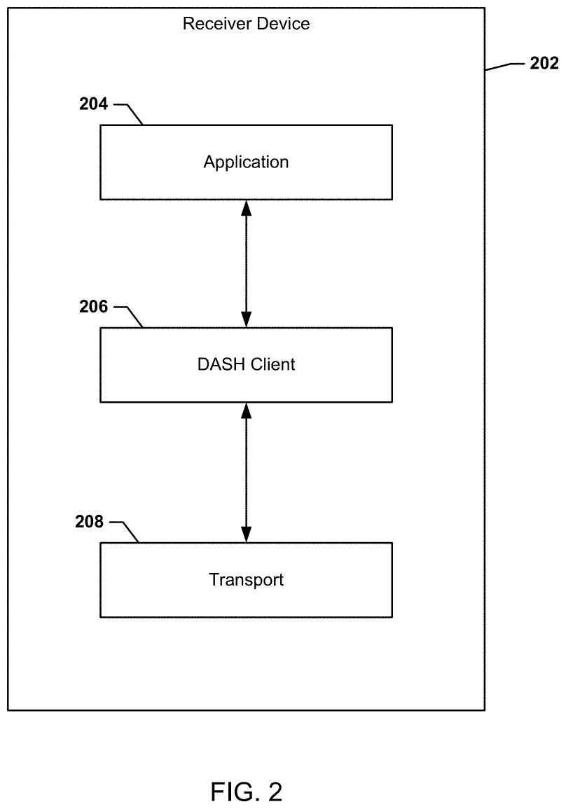

FIG. 2 illustrates a simplified receiver device 202 architecture according to an embodiment. With reference to FIGS. 1 and 2, the receiver device may be any receiver device configured to receive streaming content, such as receiver device 102, 104.

The receiver device 202 may include a transport component 208, such as a modem component, that manages all communication aspects of the receiver device 202, such as acquisition, handoff, link maintenance, etc. The transport component 208 may decode a received bearer signal and deliver Internet Protocol (IP) packets to the DASH client 206.

The DASH client 206 may be a service component (or layer) of the receiver device 202 that recovers segments from the delivered IP packets and makes segments available to applications/clients, such as media players (e.g., ABR players, etc.). As an example, the DASH client 206 may be a service component (or layer) that is part of the operating system of the receiver device 202. The DASH client 206 may also recover an MPD from the delivered IP packets. The DASH client 206 may store received segments in a memory of the receiver device 202, such as a source buffer. In an embodiment, the DASH client 206 may control provisioning of segments to the application 204. The application 204 may be an application that presents media (directly and/or via another application such as a media player). In an embodiment, the application 204 may obtain the segments from the DASH client 206 and/or the source buffer per the MPD. The application 204 may render the segment contents.

As used herein, the term “component” refers to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

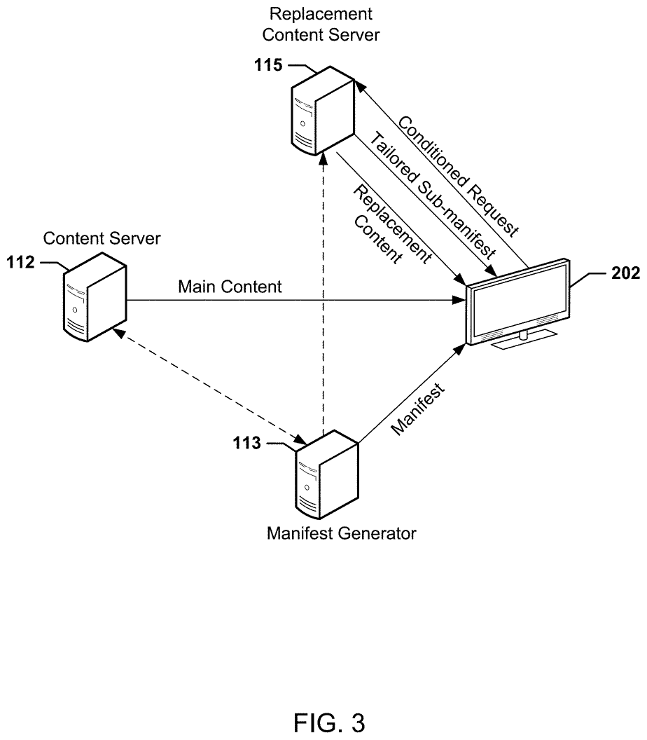

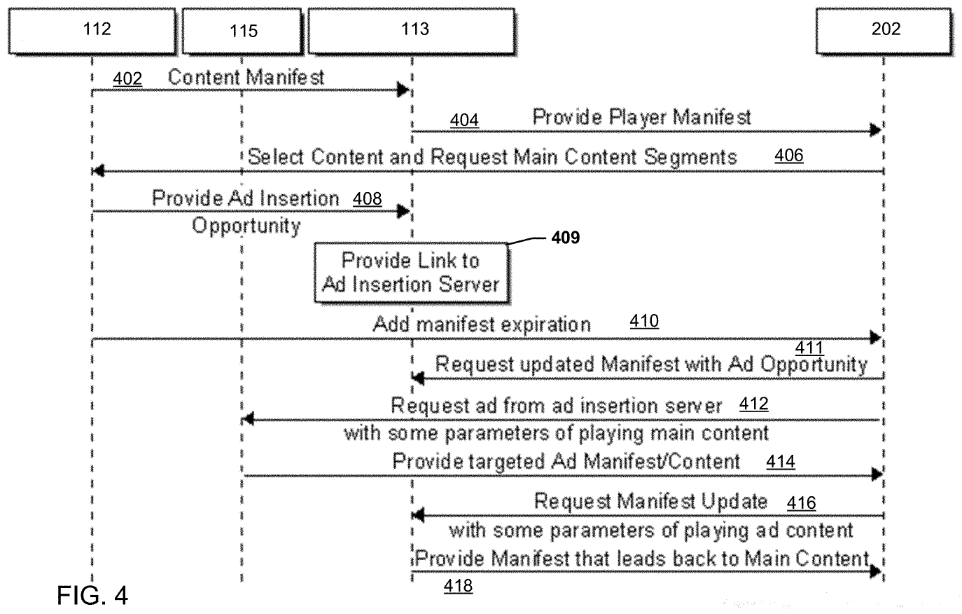

FIG. 3 illustrates a message exchange architecture between the receiver device 202, the content server 112, the manifest generator server 113, and a replacement content server 115. FIG. 4 is a call flow diagram illustrating example interactions between the receiver device 202, the content server 112, the manifest generator server 113, and the replacement content server 115 that may occur in the architecture shown in FIG. 3 to insert replacement content into a stream of main content.

With reference to FIGS. 1-4, in operation 402 the content server 112 may provide a content manifest to the manifest generator server 113 and the manifest generator server 113 may use this information in the content manifest to generate a manifest for the player of the receiver device 202. The receiver device 202 requests the manifest and receives the manifest from the manifest generator server 113 in operation 404.

In operation 406, using the manifest and based on the available content and the receiver device's 202 capabilities (also referred to as attributes), the receiver device 202 may select the proper content for playout. The proper content may be chosen based on various attributes of the receiver device 202, such as a chosen codec, spatial and temporal resolution of the display of the receiver device 202, the high-dynamic-range (HDR) capabilities of the receiver device 202, audio codec and/or rendering capabilities of the receiver device 202, etc. The main content may be requested by the receiver device 202, such as via HTTP requests. The main content may be received by the receiver device 202, such as via HTTP responses including the main content, and the DASH client 206 of the receiver device 202 may make the segments of the main content available to applications, such as an ABR player or other media player.

At some point in time, in operation 408 the content server 112 may provide an ad insertion opportunity to the manifest generator server 113. The manifest generator server 113 may provide a link to the replacement content server 115, such as an ad insertion server, in operation 409. The content server 112 may also signal the manifest (e.g., an MPD) has expired in operation 410, such as by inserting an indication into the main content to expire the manifest (e.g., the MPD) being used by receiver device 202.

Subsequently, in operation 411 the receiver device 202 requests a manifest update from the manifest generator server 113. The manifest generator server 113 may generate a manifest update with the link to the replacement content server 115 and send the manifest update to the receiver device 202 in response to the request. This manifest update may include a sub-manifest that points the receiver device 202 to the replacement content server 115, e.g., the ad insertion server.

The receiver device 202 may receive the manifest update pointing to the replacement content server 115, and in response, in operation 412, may send a conditioned request for replacement content, such as an ad, to the replacement content server 115, such as the ad insertion server. The conditioned request from the receiver device 202 may include additional parameters such that the replacement content server 115 (e.g., an ad insertion server) is aware of the currently playing content, personalization information, etc., as well as the capabilities of the receiver device 202.

As examples, the information associated with the currently playing content at the receiver device 202 may be determined by the DASH client 206 of the receiver device 202 based on the Movie Header/Initialization Segment/Common Media Application Format (CMAF) Header of each playing track which may provide a good overview on the codecs, formats, etc. being used in playout. As other examples, the information associated with the currently playing content at the receiver device 202 may be determined by the DASH client 206 of the receiver device 202 based on manifest parameters, Multipurpose Internet Mail Extension (MIME) types with codec sub-parameters, etc. The inclusion of information associated with the currently playing content may enable the replacement content server 115, to select proper replacement content that matches the current playback.

In addition, the presentation time of the last presented sample may be provided as an additional parameter in the conditioned request by the receiver device 202 in order to provide a continuous presentation. In addition, the replacement content insertion time slot, such as the ad insertion time slot, may be indicated in the conditioned request by the receiver device 202. The indication of the replacement content insertion time slot, such as the ad insertion time slot, may enable the replacement content server 115, to accurately select the replacement content and replacement content boundaries (e.g., the ad and ad boundaries). In addition, the last played timing of the main content for each media component may be provided as an additional parameter in the conditioned request by the receiver device 202. This may enable the replacement content server 115 to splice content properly, for example to avoid overlaps or to exactly splice.

The capabilities of the receiver device 202 indicated in the conditioned response may include indications related to how the receiver device 202 handles insertion of replacement content, such as ad content. As example, the capability indicated may be an indication that the receiver device 202 uses a single source buffer with static initialization, the capability indicated may be HDMI properties of the receiver device 202, the capability indicated may be an indication the receiver device 202 uses multiple source buffers, the capability indication may be an indication of the receiver device's 202 regular Media Source Extension (MSE) operation, etc.

The conditioned request from the receiver device 202 including additional parameters indicating one or more of the currently playing content information, personalization information, capabilities of the receiver device 202, etc., may be in various formats. As an example, the additional parameters of the conditioned request may be added as a query string to request itself sent to the link to the replacement content server (e.g., the Uniform Resource Locator (URL), such as the URL generated in operation 409). As another example, the additional parameters may be added as a dedicated HTTP extension header to the conditioned request manifest. As a third example, the additional parameters may be made available at a URL and the URL may be indicated in the conditioned request such that the replacement content server 115 may obtain the additional parameters at the URL.

In response to receiving the conditioned request, the replacement content server 115 (e.g., the ad insertion server) may select and properly prepare replacement content (e.g., an ad) such that playback of the replacement content (e.g., the ad) may be seamless at the receiver device 202. The additional parameters indicated in the conditioned request may make the replacement content server 115 (e.g., the ad insertion server) aware of information including the currently playing content, personalization information, etc., as well as the capabilities of the player such that the the replacement content server 115 (e.g., the ad insertion server) can provide replacement content (e.g., an ad) that enables the receiver device 202 the playout of the replacement content (e.g., an ad) in a suitable and adjusted manner This includes that the replacement content may be provisioned (specifically encoded or at least selected) to the main content to be displayable within one source buffer. Based on the sufficient knowledge on the capability of the receiver device 202, as well as on the currently playing content, the replacement content server 115 (e.g., the ad insertion server) may properly prepare and provide the replacement content such that playback is seamless.

The replacement content server 115 (e.g., the ad insertion server) may also generate a sub-manifest for the selected replacement content selected for the receiver device 202 (e.g., a tailored sub-manifest specific to the selected replacement content and the receiver device 202 it was selected for). In operation 414, the replacement content server 115 may send the replacement content (e.g., a targeted ad) and the tailored sub-manifest for the replacement content to the receiver device 202.

The receiver device 202 may receive the replacement content and insert it into the main content such that playout may be seamless. In response to inserting the replacement content, the receiver device 202 may request a manifest update in operation 416 from the manifest generator server 113. The request may indicate a parameter that indicates the replacement content was inserted.

In operation 418, in response to receiving a request for a manifest update indicated the replacement content was inserted, the manifest generator server 113 may send a manifest update (or manifest) pointing back to the content server 112 to the receiver device 202. In this manner, the receiver device 202 may use the manifest update (or manifest) pointing back to the content server 112 to return to receiving and playing out the main content.

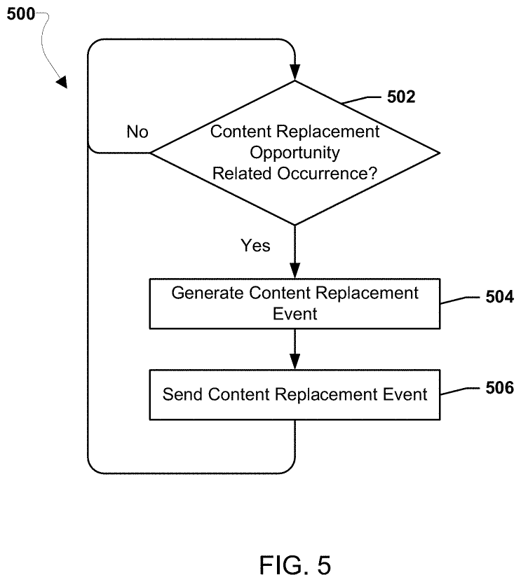

FIG. 5 illustrates a method 500 for generating content replacement events according to some embodiments. With reference to FIGS. 1-5, the method 500 may be performed by a processor of a content server, such a processor of content server 112.

In determination block 502, the processor of the content server may determine whether there is a content replacement opportunity related occurrence. A content replacement opportunity related occurrence may be any event that may be associated with starting insertion of replacement content or stopping insertion of replacement content. For example, a content replacement opportunity related occurrence may be an indication that a content replacement opportunity is available, such as an indication that an ad insertion opportunity is available in a live stream. For example, an ad opportunity may occur at a break in play of a live sporting event. As another example, a content replacement opportunity related occurrence may be an indication that a content replacement should stop, such as an indication that a live stream is returning to programming earlier than expected (e.g., a break in play of a live sporting event ends early and the broadcaster returns to coverage early).

In response to determining that there is not a content replacement opportunity related occurrence (i.e., determination block 502=“No”), the processor of the content server may continue to determine whether there is a content replacement opportunity related occurrence in determination block 502.

In response to determining that there is a content replacement opportunity related occurrence (i.e., determination block 502=“Yes”), the processor of the content server may generate a content replacement event in block 504. A content replacement event may be an event signaling a remote period to a receiver device. A content replacement event may be a timed DASH event, such as an MPD Event or inband event. A content replacement event may signal to a receiver device to insert replacement content or to resume playout of main content.

In some embodiments, content replacement events (e.g., DASH content replacement events) may be instructions in the content that the DASH client is to replace content from a specific media time onwards for some time by a period that is provided from a remote server (e.g., a replacement content server, such as an ad server, etc.). In some embodiments, these content replacement events (e.g., DASH content replacement events) may be identified by the Uniform Resource Name (URN)(“urn:mpeg : dash: event:replacement:2019”).

In some embodiments, a content author (e.g., a content server) may use such a content replacement event (e.g., DASH content replacement event) for replacing a certain part of the main content of a service and/or replacing a certain part of replacement content. In some embodiments, a content author may also use such a content replacement event (e.g., DASH content replacement event) for terminating an earlier signaled event. Early termination of such a content replacement event (e.g., DASH content replacement event) may be achieve in some embodiments by adding into a content replacement event a URN “urn:mpeg:dash:event:replacement:main:2019”.

In some embodiments, the address (e.g., a Uniform Resource Locator (URL)) to the remote server providing the remote period element (e.g., a replacement content server, such as an ad server, etc.), the start time, the considered duration, as well as other information, may be provided in a content replacement event.

In various embodiments, a content replacement event that signals a remote period may provide, at least, the start time of the content replacement opportunity (e.g., the start time of the ad insertion opportunity, etc.), the planned duration of the content replacement opportunity (e.g., the planned duration of the ad insertion opportunity, etc.), and the address (e.g., URL) where the receiver device may retrieve the remote period. In some embodiments, the start time indicated in the content replacement event maps to the media timeline. The start time may be conditioned such that it coincides with the end of a segment or a period to simplify insertion.

In some embodiments, a specific value of the start time in the content replacement event may be defined by a special event time value that indicates the content replacement event is signaling a remote period to be played when the receiver device joins the service. In some embodiments, the start time in the content replacement event may be set to the start time of the first segment of the service and the duration set to infinite (or extremely long) such that the start time and duration ensure the event will start even after the receiver device has joined the service after start time of the service. Additionally, the content replacement event may include additional information that supports the replacement content insertion process.

In some embodiments, a content replacement event may include a scheme identifier URI (e.g., @schemeldURI). The scheme identifier may be set to “urn:mpeg:dash:event:replacement:2019” to signal the content replacement event. In some embodiments, the content replacement event may include an event identifier of the content replacement event. Content replacement events may have unique content replacement identifiers such that content replacement events may be distinguished from one another. In some embodiments, the content replacement event may include a start time (e.g., start time). The start time may provide the nominal start time of the replacement content in the media timeline. In some embodiments, the content replacement event may include a value field. The value field may indicate whether the remote period indicated by the content replacement event is played from the time that matches since the start of the event has passed (e.g., by a value field setting of “1”) or whether the remote period is played from the start, regardless at what time the event is joined and played until the end (e.g., by a value field setting of “2”).

In some embodiments, the content replacement event may include a duration (e.g., duration). The duration may provide the range for which the event may be started after the start time. If set to 0, then only when media time with value start_time is played may the content replacement happens. If greater than 0, the content replacement can also happen in a media time later than start_time, maximally at start_time+duration. For preroll content replacement, start_time is set to the presentation time offset of the period and duration is set to a very large value, e.g., the expected duration of the period. In such instances, the value field may be set to “2”.

In some embodiments, the content replacement event may include a message. The message may provide a URL to a remote period. In some embodiments, the URL to the remote period may be extended with query parameters to signal the duration of the content replacement slot, as well as other parameters. For example, the URL may be extended to indicate query parameters representing the duration, the maximum duration delta (e.g., MaxDurationDelta), and/or the minimum duration delta (e.g., MinDurationDelta). The duration may provide the nominal duration of the content replacement slot. The maximum duration delta may provide the maximum duration delta of the content replacement slot and the minimum duration delta may provide the minimum duration delta of the content replacement slot.

In some embodiments, the message may be set to “urn:mpeg:dash:event:replacement:main:2019” to indicate that the Period that includes the event stream (e.g., the main content stream) is to be played. The return to the main content happens earliest at start_time, and latest at start_time+duration. Values in the content replacement event may be mapped to presentation time, duration, and the message of the event and may be carried in the MPD or inband.

In block 506, the processor of the content server may send the content replacement event to all receiver devices receiving main content from the content server, such as via the MPD and/or inband signaling.

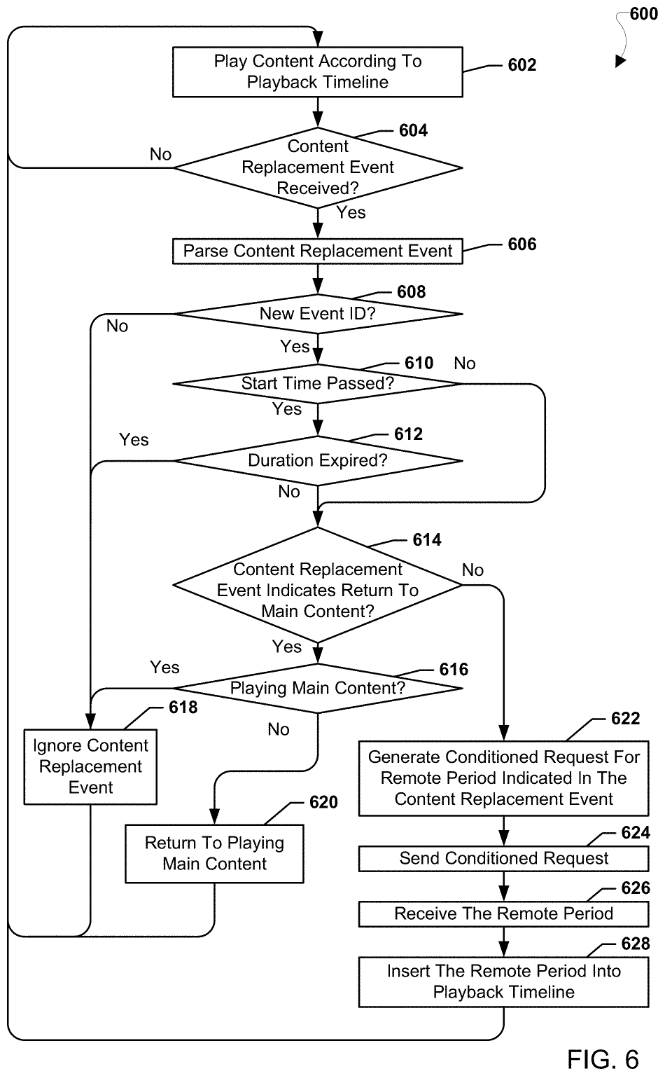

FIG. 6 illustrates a method 600 for receiving content for a streaming service according to some embodiments. With reference to FIGS. 1-6, the method 600 may be performed by a processor of a receiver device, such as a processor of receiver device 202. As an example, the operations of method 600 may be performed by DASH client 206 running on a processor of receiver device 202. In some embodiments, the operations of the method 600 may be performed in conjunction with the operations of the method 500.

In block 602, the processor of the receiver device may play content according to a playback timeline. For example, the receiver device may be connected to a content server (e.g., content server 112) and receiving main content of a stream, such as a live stream, according to an MPD. The receiver device may be requesting and receiving main content from the content server and playing the main content based on the timeline established by the DASH client of the receiver device.

In determination block 604, the processor of the receiver device may determine whether a content replacement event is received. A content replacement event may be an event signaling a remote period to a receiver device. A content replacement event may be a timed DASH event, such as an MPD Event or an inband event. A content replacement event may signal to a receiver device to insert replacement content or to resume playout of main content. As an example, a content replacement event may be generated by a remote server, such as a content server (e.g., content server 112) according to the operations of method 500. A receiver device may determine whether or not a content replacement event is received by determining whether any DASH events matching the scheme identifier associated with content replacement events are received.

In response to determining that a content replacement event is not received (i.e., determination block 604=“No”), the processor of the receiver device may continue to play content according to the playback timeline in block 602.

In response to determining that a content replacement event is received (i.e., determination block 604=“Yes”), the processor of the receiver device may parse the content replacement event in block 606. For example, the content replacement event may be parsed by the DASH client to determine information from the content replacement event to control how the content replacement event should be handled.

In determination block 608, the processor of the receiver device may determine whether the content replacement event has a new event identifier. In some embodiments, the content replacement event may include an event identifier of the content replacement event. Content replacement events may have unique content replacement identifiers such that content replacement events may be distinguished from one another. For example, parsing of the content replacement event may yield the event identifier (e.g., event ID) indicated in the content replacement event and that event identifier may be compared to a list of previously received and/or handled events to determine whether the event identifier is new or previously received/handled.

In response to determining that the content replacement event does not have a new event identifier (i.e., determination block 608=“No”), the processor of the receiver device may ignore the content replacement event in block 618. In response to ignoring the content replacement event in block 618, the receiver device may continue to play content according to the playback timeline in block 602.

In response to determining that the content replacement event has a new event identifier (i.e., determination block 608=“Yes”), the processor of the receiver device may determine whether the start time indicated in the content replacement event has passed in determination block 610. In some embodiments, the content replacement event may include a start time (e.g., start time). The start time may provide the nominal start time of the replacement content in the media timeline. The receiver device may determine whether or not the start time has passed by comparing the start time indicated in the content replacement event to the current playout time of the media stream.

In response to determining that the start time has passed (i.e., determination block 610=“Yes”), the processor of the receiver device may determine whether the event duration is expired in determination block 612. In some embodiments, the content replacement event may include a duration (e.g., duration). The duration may provide the range for which the event may be started after the start time. The receiver device may determine whether the event duration has expired by comparing the current playout time of the media stream to the time matching the start time of the event plus the duration. The current playout time of the media stream being later than the time represented by the duration plus the event start time may indicate the duration has expired.

In response to determining that the event duration has expired (i.e., determination block 612=“Yes”), the processor of the receiver device may ignore the content replacement event in block 618, and continue to play content according to the playback timeline in block 602.

In response to determining that the start time has not passed (i.e., determination block 610=“No”) or in response to determining that the event duration has not expired (i.e., determination block 612=“No”), the processor of the receiver device may determine whether the content replacement event indicates a return to main content in determination block 614. In some embodiments, the content replacement event may include a message. The message may provide a URL to a remote period or may indicate the period that includes the event stream (e.g., the main content stream) is to be played. In other words, the message may indicate the replacement content event is for a remote period or for returning to main content. In some embodiments, the message may be set to “urn:mpeg:dash:event:replacement:main:2019”. Setting the message to “urn:mpeg:dash:event:replacement:main:2019” may indicate that the Period that includes the event stream (e.g., the main content stream) is to be played.

In response to determining that the content replacement event does not indicate a return to main content (i.e., determination block 614=“No”), the processor of the receiver device may generate a conditioned request for a remote period indicated in the content replacement event in block 622. The conditioned request for a remote period indicated in the content replacement event may be a request for a remote period addressed to the address (e.g., the URL) indicated in the content replacement event, such as in the message portion of the content replacement event.

In some embodiments, the URL to the remote period may be extended with query parameters to signal the duration of the content replacement slot, as well as other parameters. For example, the URL may be extended to indicate query parameters representing the duration, the maximum duration delta (e.g., MaxDurationDelta), and/or the minimum duration delta (e.g., MinDurationDelta). The duration may provide the nominal duration of the content replacement slot. The maximum duration delta may provide the maximum duration delta of the content replacement slot and the minimum duration delta may provide the minimum duration delta of the content replacement slot.

In some embodiments, a receiver device may add query parameters to the address (e.g., the URL) indicated in a content replacement event before sending a conditioned request for the remote period referenced in the content replacement event to a remote server (e.g., a replacement content server, such as an ad server, etc.). Additional query parameters added by the receiver device may include one or more query parameters indicating one or more attributes associated with the receiver device. The one or more attributes associated with the receiver device may include a capability of the receiver device, a time slot for insertion of replacement content, one or more properties of main content, and/or a last played timing of main content.

The additional query parameters may include conditioning parameters such as the initialization sets for the content currently being played back by the receiver device. The additional query parameters may indicate the desired value of the @start attribute of the remote period in the MPD. The additional query parameters may make the remote server (e.g., a replacement content server, such as an ad server, etc.) aware of the currently playing content, personalization information, etc., as well as the capabilities of the receiver device. As examples, the information associated with the currently playing content at the receiver device may be determined by the receiver device based on the Movie Header/Initialization Segment/Common Media Application Format (CMAF) Header of each playing track which may provide a good overview on the codecs, formats, etc. being used in playout. As other examples, the information associated with the currently playing content at the receiver device may be determined based on manifest parameters, Multipurpose Internet Mail Extension (MIME) types with codec sub-parameters, etc. The inclusion of information associated with the currently playing content may enable the remote server (e.g., a replacement content server, such as an ad server, etc.) to select proper replacement content that matches the current playback.

Also, the additional query parameters may include the presentation time of the last presented sample in order to provide a continuous presentation. In addition, the replacement content insertion time slot, such as the ad insertion time slot, may be indicated as additional query parameters. The indication of the replacement content insertion time slot, such as the ad insertion time slot, may enable the remote server (e.g., a replacement content server, such as an ad server, etc.) to accurately select the replacement content and replacement content boundaries (e.g., the ad and ad boundaries). In addition, the last played timing of the main content for each media component may be provided as additional query parameters.

The capabilities of the receiver device indicated as additional query parameters may include indications related to how the receiver device handles insertion of replacement content, such as ad content. As examples, the capability indicated may be an indication the receiver device uses a single source buffer with static initialization, the capability indicated may be HDMI properties of the receiver device, the capability indicated may be an indication the receiver device uses multiple source buffers, the capability indication may be an indication of the receiver device's regular Media Source Extension (MSE) operation, etc.

In block 624, the processor of the receiver device may send the conditioned request. For example, the conditioned request may be sent to the remote server (e.g., a replacement content server, such as an ad server, etc.) address at the URL in the message of the content replacement event.

In block 626, the processor of the receiver device may receive the remote period. The remote period may include the replacement content selected by the receiver device. The remote period may include replacement content to be spliced into the main content at the start time indicated in the content replacement event. The replacement content may be tailored replacement content. As an example, the remote period may be a remote period generated according to the operations of method 700. The remote period may have a format as defined in ISO/IEC standard 23009-1.

In some embodiments, the remote period may include an indication that the replacement content for the remote period may be shortened without impacting the user experience. For example, the remote period may include an attribute (e.g., “@earlyTermination”) indicating the replacement content may be terminated earlier than the duration of the remote period. For example, the indication that early termination is acceptable for the replacement content may be an indication of a time during the ad when the audio is mute and the ad has black frames, such as the last three seconds of the ad. This mute/black frame period may permit for easier conditioning of the ad on insertion by a receiver device.

In some embodiments, the presence of both a duration attribute (e.g., “@duration”) and the attribute indicating the replacement content may be terminated earlier than the duration of the remote period (e.g., “@earlyTermination”), may signal to a receiver device that the value of the attribute indicating the replacement content may be terminated earlier than the duration of the remote period (e.g., “@earlyTermination”) specifies that the remote period may be terminated earlier by at most the value of the attribute indicating the replacement content may be terminated earlier than the duration of the remote period (e.g., “@earlyTermination”) in the playback rather than that time signaled by the duration attribute (e.g., “@duration”)

In block 628, the processor of the receiver device may insert the remote period into the playback timeline, and continue to play content according to the playback timeline in block 602.

In response to determining that the content replacement event indicates a return to main content (i.e., determination block 614=“Yes”), the processor of the receiver device may determine whether main content is playing in determination block 616. For example, the receiver device may determine whether the currently playing content is main content described in an MPD for the service or is replacement content described by a remote period to determine main content is playing.

In response to determining that main content is playing (i.e., determination block 616=“Yes”), the processor may ignore the content replacement event in block 618, and continue to play content according to the playback timeline in block 602.

In response to determining main content is not playing (i.e., determination block 616=“No”), the processor may return to playing main content in block 620. For example, if the message element of the content replacement event is set to “urn:mpeg:dash:event:replacement:main:2019” and the DASH client is playing replacement content, the DASH client may return to the main content at start time of the main content (i.e., the start time indicated in the content replacement event indicating to return to main content). If the start time has passed, but the media time is still within the duration of the content replacement event indicating to return to main content, then the return to main content may happen as soon as possible. In response to returning to playing main content in block 620, the receiver device may play content according to the playback timeline in block 602.

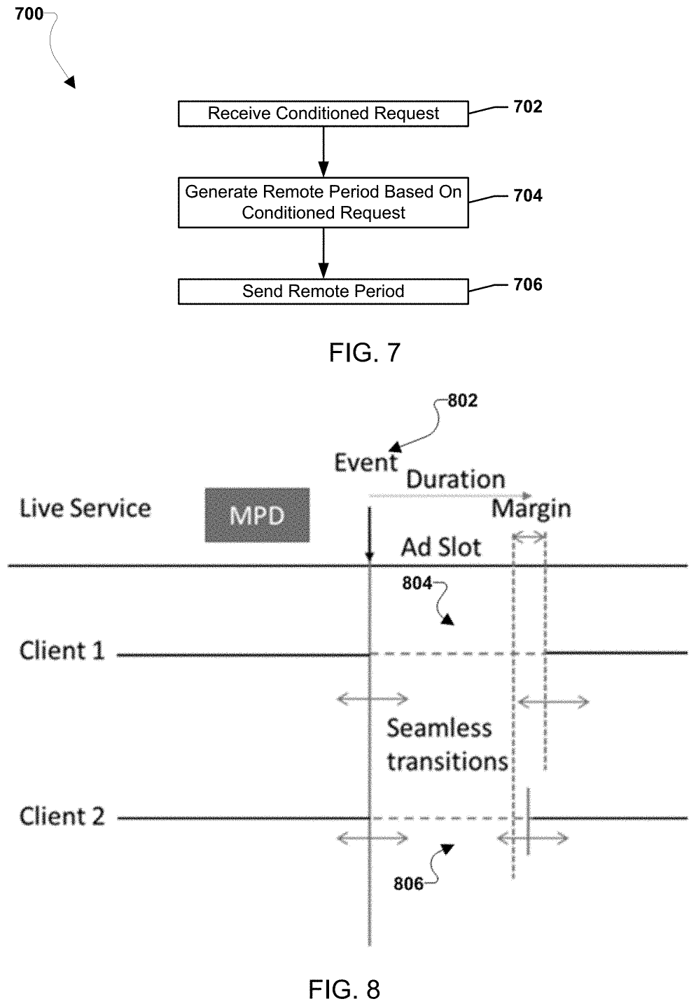

FIG. 7 illustrates a method 700 for generating a remote period according to some embodiments. With reference to FIGS. 1-7, the method 700 may be performed by a processor of a replacement content server, such as a processor of replacement content server 115. In some embodiments, the operations of the method 700 may be performed in conjunction with the operations of methods 500 and/or 600.

In block 702, the processor of the replacement content server may receive a conditioned request. A conditioned request may be a request from a receiver device for a remote period. The conditioned request may include query parameters related to the content replacement slot to be filed (e.g., an ad slot, etc.) and/or attributes of the receiver device sending the conditioned request. For example, query parameters representing the duration, the maximum duration delta (e.g., MaxDurationDelta), and/or the minimum duration delta (e.g., MinDurationDelta) of the content replacement slot. The duration may provide the nominal duration of the content replacement slot. The maximum duration delta may provide the maximum duration delta of the content replacement slot and the minimum duration delta may provide the minimum duration delta of the content replacement slot.

As another example, query parameters representing one or more attributes associated with the receiver device may include query parameters representing a capability of the receiver device, query parameters representing a time slot for insertion of replacement content, query parameters representing one or more properties of main content, and/or query parameters representing a last played timing of main content. The capabilities of the receiver device indicated as additional query parameters may include indications related to how the receiver device handles insertion of replacement content, such as ad content. As examples, the capability indicated may be an indication the receiver device uses a single source buffer with static initialization, the capability indicated may be HDMI properties of the receiver device, the capability indicated may be an indication the receiver device uses multiple source buffers, the capability indication may be an indication of the receiver device's regular Media Source Extension (MSE) operation, etc. Query parameters may include conditioning parameters such as the initialization sets for the content currently being played back by the receiver device. Query parameters may indicate the desired value of the @start attribute of the remote period in the MPD.

In block 704, the processor of the replacement content server may generate a remote period based on the conditioned request. The additional query parameters may make the replacement content server aware of the currently playing content, personalization information, etc., as well as the capabilities of the receiver device. This information from the conditioned request may be used to select and prepare replacement content and a remote period for that replacement content that is tailored to the replacement content time slot and the receiver device itself that requested the replacement content. In this manner, replacement content may be tailored replacement content that is uniquely selected for each receiver device. In some embodiments, the remote period may have a format as defined in ISO/IEC standard 23009-1.

In some embodiments, the remote period may include an indication that the replacement content for the remote period may be shortened without impacting the user experience. For example, the remote period may include an attribute (e.g., “@earlyTermination”) indicating the replacement content may be terminated earlier than the duration of the remote period. For example, the indication that early termination is acceptable for the replacement content may be an indication of a time during the ad when the audio is mute and the ad has black frames, such as the last three seconds of the ad. This mute/black frame period may permit for easier conditioning of the ad on insertion by a receiver device. In some embodiments, the presence of both a duration attribute (e.g., “@duration”) and the attribute indicating the replacement content may be terminated earlier than the duration of the remote period (e.g., “@earlyTermination”), may signal to a receiver device that value of the attribute indicating the replacement content may be terminated earlier than the duration of the remote period (e.g., “@earlyTermination”) specifies that the remote Period may be terminated earlier by at most the value of the attribute indicating the replacement content may be terminated earlier than the duration of the remote period (e.g., “@earlyTermination”) in the playback rather than the time signaled by the duration attribute (e.g., “@duration”).

In block 706, the processor of the replacement content server may send the remote period to the requesting receiver device including the tailored replacement content such that the receiver device may receive the remote period an insert the remote period into its respective playback timeline.

FIG. 8 is a timeline of playout of a streaming service in response to a content replacement event at two different receiver devices (e.g., Client 1 and Client 2) according to various embodiments. With reference to FIGS. 1-8, the timeline of playout may reflect the receiver devices (e.g., Client 1 and Client 2) performing operations of method 600 and being in communication with a content server performing operations of method 500 and a replacement content server performing operations of method 700. As examples, the receiver devices (e.g., Client 1 and Client 2) may each be similar to receiver device 202, the content server may be similar to content server 112, and the replacement content server may be similar to replacement content server 115.

As illustrated in FIG. 8, Client 1 and Client 2 may both be playing out main content of a live service according to an MPD of that service. At some time, the content server may send a content replacement event 802 to the devices connected to the service, such as Client 1 and Client 2. The content replacement event may indicate the start time for an ad slot, a duration of the ad slot, and the URL of the ad server from which devices are to retrieve a remote period for the ad slot. The URL may include additional parameters, such as a maximum duration delta which may enable the ad slot to be extended past the duration.

The content replacement event 802 may start at the same time for all devices and may have a duration reflecting the ad slot length. Each Client 1 and Client 2 may send its own conditioned request to the URL for the remote period and the ad server may return different remote periods for different ads to each Client 1 and Client 2 tailored to that device. For example, Client 1's ad may be longer than Client 2's ad, thereby making Client 1's ad slot 804 longer than Client 2's ad slot 806. The Client 1 may insert its received remote period into its playback timeline and playout its ad during its ad slot 804. The Client 2 may insert its received remote period into its playback timeline and playout its ad during its ad slot 806. As the ad slot 806 is shorter than the ad slot 804, the Client 2 may return to the main content before the Client 1.

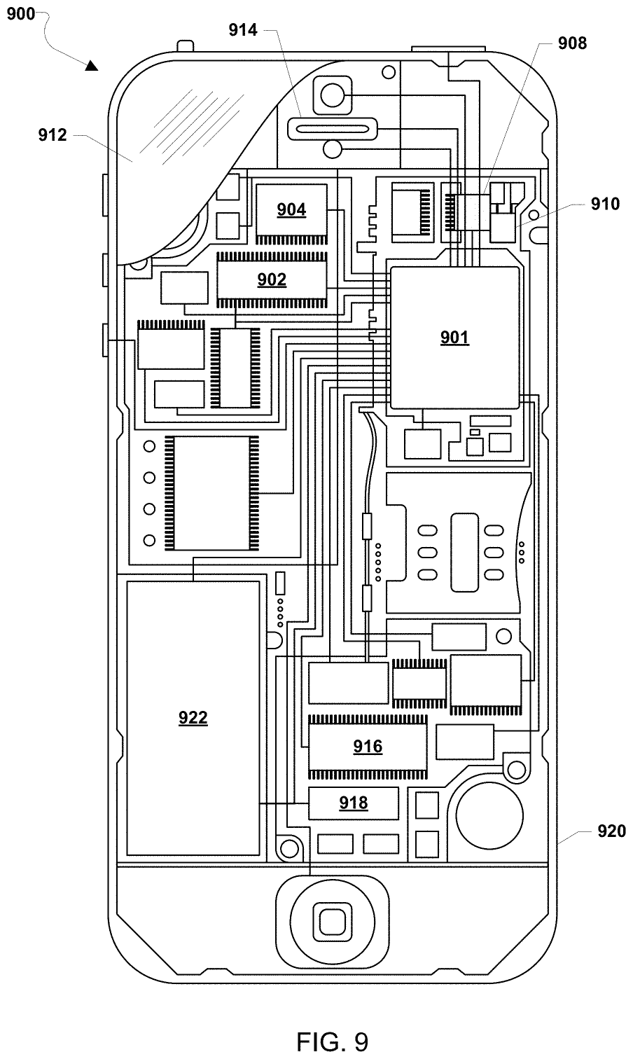

Various embodiments (including, but not limited to, embodiments discussed above with reference to FIGS. 1-8) may be implemented in any of a variety of receiver devices, an example of which is illustrated in FIG. 9 as a mobile computing device 900. With reference to FIGS. 1-8, for example, the mobile computing device 900 may include a processor 901 coupled to a touch screen controller 904 and an internal memory 902. The processor 901 may be one or more multicore integrated circuits (ICs) designated for general or specific processing tasks. The internal memory 902 may be volatile or non-volatile memory, and may also be secure and/or encrypted memory, or unsecure and/or unencrypted memory, or any combination thereof. The touch screen controller 904 and the processor 901 may also be coupled to a touch screen panel 912, such as a resistive-sensing touch screen, capacitive-sensing touch screen, infrared sensing touch screen, etc. The mobile computing device 900 may have one or more radio signal transceivers 908 (e.g., Peanut®, Bluetooth®, Zigbee®, Wi-Fi, RF, cellular, etc.) and antennae 910, for sending and receiving, coupled to each other and/or to the processor 901. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor. The mobile computing device 900 may include a peripheral device connection interface 918 coupled to the processor 901. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown). The mobile computing device 900 may also include speakers 914 for providing audio outputs. The mobile computing device 900 may also include a housing 920, constructed of a plastic, metal, or a combination of materials, for containing all or some of the components discussed herein. The mobile computing device 900 may include a power source 922 coupled to the processor 901, such as a disposable or rechargeable battery. The rechargeable battery may also be coupled to the peripheral device connection port to receive a charging current from a source external to the mobile computing device 900.

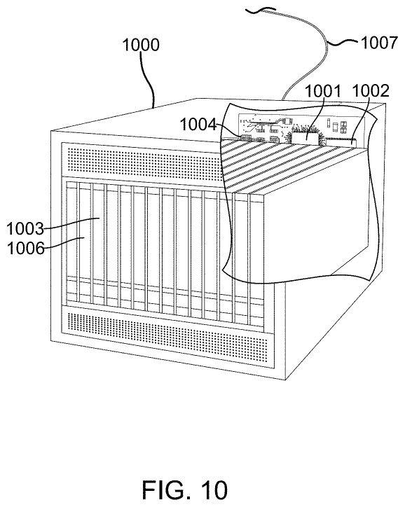

Various embodiments (including, but not limited to, embodiments discussed above with reference to FIGS. 1-8) may be implemented in any of a variety of commercially available server devices, such as the server 1000 illustrated in FIG. 10. With reference to FIGS. 1-8, such a server 1000 typically includes a processor 1001 coupled to volatile memory 1002 and a large capacity nonvolatile memory, such as a disk drive 1003. The server 1000 may also include a floppy disc drive, compact disc (CD) or DVD disc drive 1006 coupled to the processor 1001. The server 1000 may also include one or more network transceivers 1004, such as a network access port, coupled to the processor 1001 for establishing network interface connections with a communication network 1007, such as a local area network coupled to other announcement system computers and servers, the Internet, the public switched telephone network, and/or a cellular network (e.g., CDMA, TDMA, GSM, PCS, 3G, 4G, 5G, LTE, or any other type of cellular network).

The processor (e.g., 901, 1001) may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory before they the software applications are accessed and loaded into the processor (e.g., 901, 1001). The processor (e.g., 901, 1001) may include internal memory sufficient to store the application software instructions. In many devices, the internal memory may be a volatile or nonvolatile memory, such as flash memory, or a mixture of both. For the purposes of this description, a general reference to memory refers to memory accessible by the processor (e.g., 901, 1001), including internal memory or removable memory plugged into the device and memory within the processor (e.g., 901, 1001) itself

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, components, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, components, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A receiver device, comprising:
a processor configured to:
receive a content replacement event, wherein the content replacement event indicates at least a start time and an address for a remote content;
generate a conditioned request for the remote content indicated in the content replacement event;
send the conditioned request to the address for the remote content;
receive the remote content from a replacement content server in response to sending the conditioned request; and
insert the remote content into a playback timeline at the start time indicated in the content replacement event.

2. The receiver device of claim 1, wherein the remote content is a remote period.

3. The receiver device of claim 2, wherein the address for the remote period indicated in the content replacement event is extended with query parameters.

4. The receiver device of claim 3, wherein the query parameters indicate at least a duration of a slot for content replacement.

5. The receiver device of claim 1, wherein the processor is further configured to generate the conditioned request for the remote content indicated in the content replacement event by adding one or more query parameters indicating one or more attributes associated with the receiver device.

6. The receiver device of claim 5, wherein the processor is further configured such that the one or more attributes associated with the receiver device comprise a capability of the receiver device, a time slot for insertion of replacement content, one or more properties of main content, or a last played timing of main content.

7. The receiver device of claim 1, wherein the processor is further configured to:
parse the content replacement event to determine attributes of the content replacement event before generating the conditioned request;
determine whether an event identifier of the content replacement event is new before generating the conditioned request;
ignore the content replacement event in response to determining that the event identifier of the content replacement event is not new; and
generate the conditioned request for the remote content indicated in the content replacement event by generating the conditioned request for the remote content indicated in the content replacement event in response to determining that the event identifier of the content replacement event is new.

8. The receiver device of claim 1, wherein:
the content replacement event further indicates a duration; and
the processor is further configured to:
determine whether the start time indicated in the content replacement event has passed before generating the conditioned request;
determine whether the duration has expired in response to determining that the start time has passed and before generating the conditioned request;
ignore the content replacement event in response to determining that the start time has passed and the duration has expired; and
generate the conditioned request for the remote content indicated in the content replacement event by generating the conditioned request for the remote content indicated in the content replacement event in response to determining that the start time has not passed or that the start time has passed and the duration has not expired.

9. The receiver device of claim 1, wherein the processor is further configured to:
receive a second content replacement event, wherein the content replacement event indicates at least a second start time and a return to main content; and
return to playing main content at the second start time in response to receiving the second content replacement event.

10. The receiver device of claim 1, wherein the remote content includes replacement content to be spliced into main content at the start time indicated in the content replacement event.

11. The receiver device of claim 10, wherein the replacement content is tailored replacement content.

12. The receiver device of claim 10, wherein the replacement content is filled for a duration of the remote content.

13. The receiver device of claim 12, wherein the remote content indicates the replacement content may be terminated earlier than the duration of the remote content.

14. The receiver device of claim 10, wherein the processor is further configured to splice the replacement content into main content.

15. The receiver device of claim 14, wherein the processor is further configured to splice the replacement content into the main content by adjusting a duration of the replacement content in response to the remote content indicating that the replacement content may be terminated earlier than the duration of the remote content.

16. The receiver device of claim 15, wherein the main content and replacement content are Dynamic Adaptive Streaming Over Hypertext Transfer Protocol (DASH) content.

17. The receiver device of claim 16, wherein the processor is further configured to play the main content and the replacement content from a same buffer seamlessly.

18. A method for receiving content for a streaming service, comprising:
receiving, by a processor of a receiver device, a content replacement event, wherein the content replacement event indicates at least a start time and an address for a remote content;
generating, by the processor, a conditioned request for the remote content indicated in the content replacement event;
sending, by the processor, the conditioned request to the address for the remote content;
receiving, by the processor, the remote content from a replacement content server in response to sending the conditioned request; and
inserting, by the processor, the remote content into a playback timeline at the start time indicated in the content replacement event.

19. The method of claim 18, wherein the remote content is a remote period.

20. The method of claim 19, wherein:
the address for the remote period indicated in the content replacement event is extended with query parameters; and
the query parameters indicate at least a duration of a slot for content replacement.

21. The method of claim 18, wherein generating the conditioned request for the remote content indicated in the content replacement event comprises adding one or more query parameters indicating one or more attributes associated with the receiver device, wherein the one or more attributes associated with the receiver device comprise a capability of the receiver device, a time slot for insertion of replacement content, one or more properties of main content, or a last played timing of main content.

22. The method of claim 18, further comprising:
parsing, by the processor, the content replacement event to determine attributes of the content replacement event before generating the conditioned request;
determining, by the processor, whether an event identifier of the content replacement event is new before generating the conditioned request; and
ignoring, by the processor, the content replacement event in response to determining that the event identifier of the content replacement event is not new,
wherein generating the conditioned request for the remote content indicated in the content replacement event comprises generating, by the processor, the conditioned request for the remote content indicated in the content replacement event in response to determining that the event identifier of the content replacement event is new.

23. The method of claim 18, wherein the content replacement event further indicates a duration, the method further comprising:
determining, by the processor, whether the start time indicated in the content replacement event has passed before generating the conditioned request;
determining, by the processor, whether the duration has expired in response to determining that the start time has passed and before generating the conditioned request; and
ignoring, by the processor, the content replacement event in response to determining that the start time has passed and the duration has expired,
wherein generating the conditioned request for the remote content indicated in the content replacement event comprises generating, by the processor, the conditioned request for the remote content indicated in the content replacement event in response to determining that the start time has not passed or that the start time has passed and the duration has not expired.

24. The method of claim 18, further comprising:
receiving, by the processor, a second content replacement event, wherein the content replacement event indicates at least a second start time and a return to main content; and
returning, by the processor, to playing main content at the second start time in response to receiving the second content replacement event.

25. The method of claim 18, wherein the remote content includes replacement content to be spliced into main content at the start time indicated in the content replacement event, the method further comprising splicing, by the processor, the replacement content into the main content.

26. The method of claim 25, wherein:
the replacement content is tailored replacement content and is filled for a duration of the remote content; and
the remote content indicates the replacement content may be terminated earlier than the duration of the remote content.

27. The method of claim 25, wherein splicing the replacement content into the main content comprises adjusting, by the processor, a duration of the replacement content in response to the remote content indicating that the replacement content may be terminated earlier than the duration of the remote content.

28. The method of claim 27, wherein the main content and replacement content are Dynamic Adaptive Streaming Over Hypertext Transfer Protocol (DASH) content, the method further comprising playing the main content and the replacement content from a same buffer seamlessly.

29. A computing device, comprising:
means for receiving a content replacement event, wherein the content replacement event indicates at least a start time and an address for a remote content;
means for generating a conditioned request for the remote content indicated in the content replacement event;
means for sending the conditioned request to the address for the remote content;
means for receiving the remote content from a replacement content server in response to sending the conditioned request; and
means for inserting the remote content into a playback timeline at the start time indicated in the content replacement event.

30. A non-transitory processor readable medium having stored thereon processor-executable instructions configured to cause a processor of a computing device to perform operations comprising:
receiving a content replacement event, wherein the content replacement event indicates at least a start time and an address for a remote content;
generating a conditioned request for the remote content indicated in the content replacement event;
sending the conditioned request to the address for the remote content;
receiving the remote content from a replacement content server in response to sending the conditioned request; and
inserting the remote content into a playback timeline at the start time indicated in the content replacement event.
